(19) United States
(12) Patent Application Publication
(10) Pub. No.: US 2002/0166253 A1
(43) Pub. Date: Nov. 14, 2002

(54) Overhead tool

(76) Inventors: Rocky Wayne Brakebill, Portales, NM (US); Carla Brakebill, Portales, NM (US)

Correspondence Address: Rocky W. Brakebill, 108 New Mexico Drive, Portales, NM, 88130, US

(21) Appl. No.: 10/022,752

(22) Filed: Dec. 12, 2001

Related U.S. Application Data
(60) Provisional application No. 60/254,564, filed on Dec. 12, 2000.

(51) Int. Cl. G01D 21/00

(52) U.S. Cl. 33/611

(57) ABSTRACT

The Overhead Tool is designed to take the guesswork out of the critical adjustment of the valves and injectors. It is also capable of sliding across the entire valve and injector train to adjust each valve or injector that accounts for the accuracy of the tool. (For instance, instead of setting the valve or injector according to a recommended range, you can set them exactly to specifications of the particular engine). A feeler gage is inferior to this tool because of the stability and rigidity that allows for the accuracy of this tool.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO A MICROFICHE APPENDIX

“Not Applicable”

### BACK GROUND OF THE INVENTION

Diesel engines power heavy-duty trucks, tractors, construction equipment, and some automobiles and pick up trucks. It is through the use of diesel engine power that much of the heavy work of industrial nations is performed. One of the areas of concern for the public, governmental agencies, and industries that primarily depend on the diesel engine is that of engine efficiency in relation to performance and emissions regulations. It is important to ensure that the present style engine is maintained properly and regularly so that the performance level is at a high standard. Unfortunately, the drive for reduced emissions from diesel exhausts in the recent past has led to some problems with current engine performance. For example, the amount of oil present in the air stream in automotive diesel engines has been reduced. This has led to an increase in the wear of inlet valves and seat inserts in diesel engines. In order to minimize the damage resulting from this reduction, regular and accurate valve maintenance as well as injector maintenance must be preformed.

### BRIEF SUMMARY OF THE INVENTION

A new Invention, Overhead Tool, would serve to provide a more accurate setting of valves and injectors on diesel engines. At this time, the human hand performs the setting of these valves and injectors. The trained diesel mechanic with a number of years of experience can set the valves and injectors with a high degree of accuracy in this manner. But, with Overhead Tool, the guesswork and feel of the work is eliminated. Overhead Tool would bring more accuracy into adjustments on valves and injectors through the use of mechanical dial indicators. No longer would human miscalculations result in readjustments and loss of equipment work time. Overhead Tool could save time, energy, and money for consumers and many of our nation's large industries.

### BRIEF DESCRIPTION OF THE SEVERAL VIEWS OF THE DRAWING

FIG. 1. This shows the complete Overhead Tool that consists of: The main shaft used to mount on the engine in which you are working. Threaded hexagon mounting bolts appear at both ends of the main shaft inside of the adjustment space. This adjustment space is for adjusting the Overhead Tool on different types and styles of engines. The hexagon mounting bolts have threads and a jam nut on both ends in order to mount the main shaft to the engine. The sliding sleeve is allowed to slide back and forth on the main shaft in order to adjust the valves or injectors on a given cylinder. The typical dial indicator is mounted on the sliding sleeve with a bolt through the mounting eyes. There is a hand-securing knob on both sides of the dial indicator in order to secure it to the main shaft above the cylinder that is to be adjusted.

FIG. 2, Section A-A shows the side view of the sliding sleeve, the hand-securing knob and the mounting eyes in which the typical dial indicator will be placed.

FIG. 3 Detail A is the exploded view of the threaded hexagon mounting bolt which extends through the adjustment space and is secured by the washer and nut.

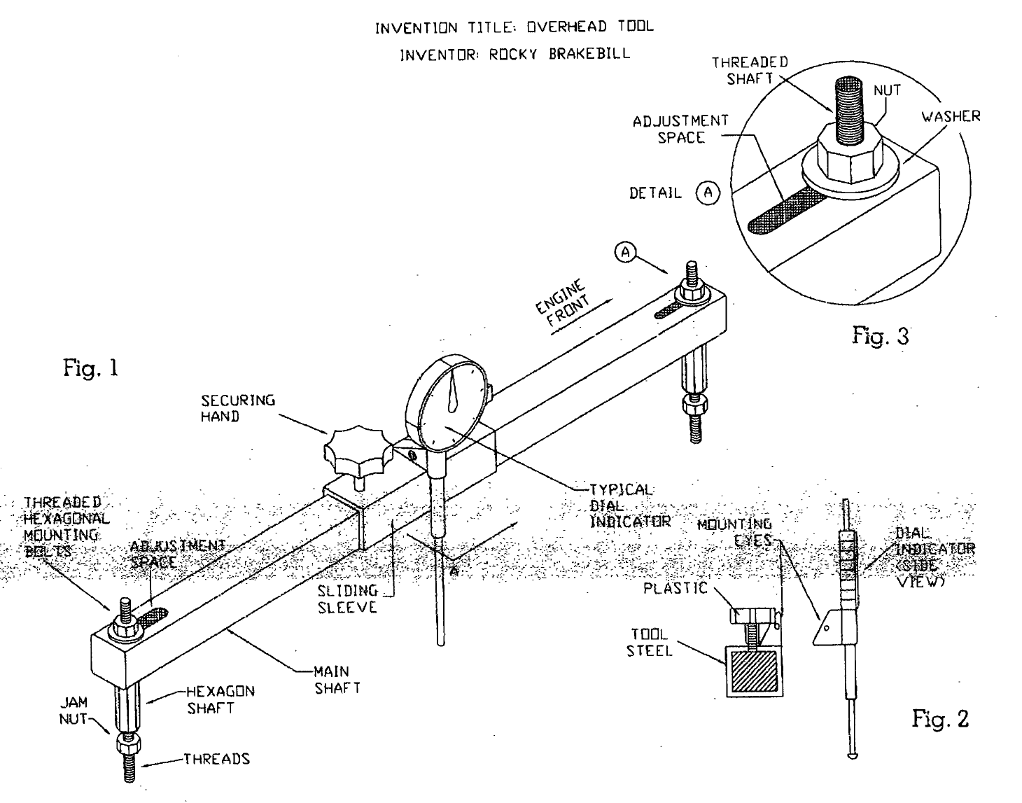

### DETAILED DESCRIPTION OF THE INVENTION

The design for the Overhead Tool calls for a metal shaft with interchanging mounting adaptor attachments. The dimensions of the product would vary according to the size of the diesel engine on which it would be fitted. The major components would consist of a dial indicator, standard shaft tool steel, a sliding sleeve, and sets of mounting adaptors. There are two mounting eyes on the sliding sleeve allowing the dial indicator to be moved from one to another during use and removed when not in use. Knobs that could be tightened by hand would also be needed to allow the Overhead Tool to function as designed. The use of tool steel in much the production of the product is recommended.

The Overhead Tool is mounted on the cylinder head with the appropriate adaptor for that engine. The Overhead Tool will perform valve and injector adjustments with no tolerance according to book specifications. The mounting adaptor will extend a short distance from the top of the engine covering and valve and valve injector train. The main shaft would extend between the adaptors and would hold the other components in place. Upon the main shaft, a dial indicator is mounted on the sliding sleeve that slides the length of the shaft. Hand securing knobs on both sides of the dial indicator make the indicator rigid in order to measure valve clearance and/or injector plunger travel.

What I claim as my invention is:

1. A tool for setting the valves and injectors on diesel engines having a metal shaft with adjustable and interchangeable mounting adaptors in order to be used on different types of engines, upon the shaft is a sliding sleeve which is capable of sliding the length of the shaft in order to move to a different valve or injector then a dial indicator is mounted on the sliding sleeve through one of the two eyelets, in order to stabilize this sleeve for adjustment, the hand securing knobs on both sides of the dial indicator must be tightened, once this is done the Overhead Tool can work properly.
